(19) United States
(12) Patent Application Publication
(10) Pub. No.: US 2020/0080882 A1
(43) Pub. Date: Mar. 12, 2020

(54) SYSTEMS AND METHODS FOR AUTOMATED FLOOD RESPONSE

(71) Applicants: Mark Schnably, Winston-Salem, NC (US); Michael Gruver, Winston-Salem, NC (US)

(72) Inventors: Mark Schnably, Winston-Salem, NC (US); Michael Gruver, Winston-Salem, NC (US)

(21) Appl. No.: 16/125,618

(22) Filed: Sep. 7, 2018

(51) Int. Cl. G01F 23/00; G05B 19/042; E01F 13/06

(52) U.S. Cl. CPC G01F 23/0076; G05B 19/0428; E01F 13/06; G01W 1/14; G05B 2219/25202; G05B 2219/24015; G05B 2219/25338

(57) ABSTRACT

Systems and methods are provided for providing detection of water levels and deployment of barrier devices. The system may include water level sensors which may detect a change in water levels at a geographic location and transmit a command to at least one barrier device in response to the water level reaching a certain level. The water level sensor may receive water level measurements and determine whether the detected water level satisfies at least one deployment condition. The deployment conditions may include a threshold value. Upon determining that the water level corresponds to the threshold value, a command may be transmitted to the barrier device. The command may instruct the barrier device to be deployed. The deployed barrier device may block an entrance to potential motorists attempting to cross a road.

### TECHNICAL FIELD

The present disclosure is generally related to flood monitoring and warning. More particularly, the present disclosure is directed to systems and methods for real-time flood monitoring and deployment of a road barrier in the event a determination of unsafe road conditions is made.

### BACKGROUND

Of all weather-related disasters that occur in the United States, floods are the main cause of death, and most flood-related deaths are attributed to flash floods. Over the past thirty years, on average, an estimated 2,500 deaths were associated with flash floods, with an average of eighty-five deaths per flash flood. More than twice as many deaths were associated with flash floods for which the warnings were considered inadequate than with those with warnings considered adequate. Ninety-three percent of the deaths were due to drowning and forty-two percent of these drownings were automobile related. For example, in 2015, about sixty-four percent of the flood deaths involved vehicles. Many of those likely occurred when a person was trying to cross a flooded road. The other drownings occurred in homes, at campsites, or when persons were crossing bridges and streams.

Most flash flooding is caused by slow-moving thunderstorms, thunderstorms repeatedly moving over the same area, or heavy rains from hurricanes and tropical storms. Flash flooding is affected by rainfall intensity and duration. Topography, soil conditions, and ground cover also play an important role.

Usually, flash floods occur within a few minutes or hours of excessive rainfall, a dam or levee failure, or a sudden release of water held by an ice jam. Flash floods can roll boulders, tear out trees, destroy buildings and bridges, and scour out new channels. Rapidly rising water can reach heights of thirty feet or more. Furthermore, flash flood-producing rains can also trigger catastrophic mud slides. Occasionally, floating debris or ice can accumulate at a natural or man-made obstruction and restrict the flow of water. Water held back by the ice jam or debris dam can cause flooding upstream. Subsequent flash flooding can occur downstream if the obstruction should suddenly release.

Advanced warning of flash floods is critical to saving lives. Warning systems of these deadly, sudden floods are not always adequate. Vehicles have been a part of many flood-related fatalities. Current solutions include flood warnings issued by national or local authorities. However, not all communities are subject to a flood warning program. Similarly, dispatching first responders to the affected areas to erect temporary barriers to discourage vehicles from entering flooded road is not always effective. Indeed, many will attempt to cross a flooded road before the first responders arrive. In fact, many of flash flood fatalities involve motorists being swept away on flooded roads due to inability to accurately assess the depth of floodwater, particularly at night. Accordingly, a need for an automatic real-time flood detection system that prevents vehicles from entering a road that may be subject to flooding exists.

### SUMMARY

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In accordance with one or more embodiments, various features and functionality can be provided to enable or otherwise facilitate detection of water levels and deployment of barrier devices. Particularly, a flood monitoring and response system may include water level sensors which may detect a change in water levels at a geographic location and transmit a command to at least one barrier device in response to the water level reaching a certain level.

In one embodiment, the flood monitoring and response system includes at least one water level sensor configured to measure a change in water levels provided at a geographic location. The water level sensor includes a sensor communication module physically connected to the water level sensor and configured to receive water level measurements. The water level measurements may be indicative of the water level measured at geographic location. The system uses the water measurements to determine whether the detected water level satisfies at least one deployment condition. The deployment conditions may include a threshold value corresponding to a threshold water level that may be specified by a user or determined by the system.

In particular, the sensor communication module includes electronics configured to process a data stream associated with a water level measured by the water level sensor in order to generate a command that includes instructions transmitted via a wireless communication signal to at least one barrier device. Instructions transmitted to the barrier device may include a command that places the barrier device from an undeployed position to a deployed position. In the deployed position, the barrier device may create physical barrier by blocking an entrance to potential motorists attempting to cross a road. Further, in its deployed position, the barrier device may warn individuals that the road is too dangerous and may be subject to increased water levels, and, thus, should not be crossed. Further still, in some implementations, the system may use the water level information as well as data received from other sources to determine whether the water level satisfies at least deployment condition.

In some embodiments, the water level sensor may be placed at a user specified location. The water level sensor may be installed or mounted using existing structures or user installed structures. For example, the water level sensor may be adjustably mounted on a tree or a utility pole. In some embodiments, the water level sensor may be mounted on a structural component specifically installed to hold the water level sensor (e.g., a post or a riser). The water level sensor may be mounted at a desired monitoring level. For example, the water level sensor may be mounted in close proximity to the surface of the ground in order detect the threshold water level.

In some embodiments, the water level sensor may be configured to detect a threshold level of water (e.g., six inches). The threshold water level may be specified by a user, determined by the system, or otherwise obtained. The water level sensor may detect the threshold level of water via the float sensor. Upon the water reaching the threshold level, the float sensor may generate a signal that the threshold water level has been reached.

In some embodiments, the water level sensor may include a float sensor. The float sensor of the water level sensor may include a mechanical switch having an electrode that, when water is present, may be triggered when positive and negative electrodes are connected. In some embodiments, the float sensor of water level sensor 108 may include a float. The increase in water may move the float which may trigger the float sensor located at a user specified location. In some embodiments, the float sensor may also detect the movement of the float as the water raises. When the float sensor is activated, the float sensor may send an electronic signal to the sensor communication module. The sensor communication module may determine that the water level, as indicated by float sensor signal, corresponds to the threshold water level and transmit a command to a number of barrier devices.

Alternatively, the water level sensor may include other types of water level sensors such as float levers, mechanical switches, and/or other such sensors. By way of example, the water level sensor may include a water pressure detector to detect water pressure at geographic location where the water sensor is placed. The water pressure may be used to determine a water level on the basis of the water pressure detected by the water pressure detector. The water pressure detector may obtain water pressure by detecting a pressure difference between water pressure applied to a lower surface of the water detector and an atmospheric pressure applied to an upper surface of the water detector. This detected pressure differential may be converted into an electric signal used to determine the water level.

In some embodiments, the water level sensor may measure the water level continuously or periodically (e.g., at specified time intervals). The time intervals at which the water sensor may measure the water level may be specified by a user, determined by the system, or otherwise obtained. In some embodiments, the measurement information obtained by the water level sensor may be transmitted to a system server indicating that the water levels have reached a certain level.

In some embodiments, the flood monitoring and response system may include a water detection system and at least one of the plurality of barrier devices, as well as the communications therebetween. The water detection system may include the water level sensor coupled to a sensor measurement circuit for processing and managing sensor data. The sensor measurement circuit may be coupled to a processor. In some embodiments, the processor may perform part or all of the functions of the sensor measurement circuit for obtaining and processing sensor measurement values from the water level sensor. The processor may be further coupled to a radio unit or a transceiver for sending requests and commands to an external device, such as a barrier device. In response to a command from the processor, the barrier device may be deployed by blocking entrance of users onto a road. The barrier device may utilize the transceiver and the processor to execute commands received from the processor. The water detection system may further include a memory and a real time clock (RTC) for storing and tracking sensor information.

Wireless communication protocols may be used to transmit and receive data between the water detection system and the barrier device. The wireless communication protocol used may be designed for use in a wireless sensor network that is optimized for periodic and small data transmissions (that may be transmitted at low rates if necessary) to and from multiple devices in a close range (e.g., a personal area network (PAN)).

In some embodiments, upon the sensor communication module determining that the water level, as communicated by the water level sensor, corresponds to a threshold water level, a command comprising command information may be transmitted to a number of barrier devices.

In some embodiments, the barrier device may include a stationary arm and a movable arm. The barrier device may receive command information including a command instructing the barrier device to deploy the movable arm and thus prevent vehicles from entering a road which may be subject to flooding. Additionally, the barrier device that has received the command to deploy the movable arm may signal pedestrians that entering a particular road is dangerous and/or undesirable.

In some embodiments, the barrier device may further include a radio unit or a transceiver for receiving deployment instruction information and for sending requests, instructions, and data to a remote server and/or associated databases that may be included in the flood monitoring and response system. The transceiver may further employ a wireless communication protocol. The memory may also be used for storing an operating a system and/or a custom (e.g., proprietary) application designed for wireless data communication between the water level sensor and the barrier device.

The command information may be executed by the processor to control and the barrier device. It should be understood that in the case of barrier device, command information, alerts and/or sensor information provided by the water level sensor vis-à-vis a sensor communication module can be used to deploy the movable arm from a vertical position to a horizontal position to signal to the public that the road is flooded.

In some implementations, barrier devices may be installed on either side of a flooded road. Barrier devices installed in such a manner may be communicatively coupled and may be operated in a synchronized manner. For example, upon receiving command information, provided by the water level sensor, to deploy the movable arm from a vertical position to a horizontal position, a barrier device installed on a first side of a road may transmit a signal to another barrier device installed on a second side of the same road.

In some embodiments, the sensor communication module physically connected to the water level sensor may be configured to transmit commands based on the water level measurements to an assigned barrier device. That is, each water level sensor may be configured to communicate with only one barrier device. Additionally, water level sensor and barrier device pairs may be configured to operate in a pattern, such that transmission of a deployment command from the water sensor to the barrier device may automatically cause the water sensor to transmit a deployment command to the barrier device. The pattern of operation may be specified by a user or may be determined by the monitoring and response system. This determination by the flood monitoring and response system may be based on data received from additional sources and or inputs.

In some embodiments, the flood monitoring and response system may receive external data from various sources outside systems. For example, weather report information, historical weather information, historical flood information may be received for the geographic location of water level sensor 108, barrier device, and/or other component of the system. The flood monitoring and response system may transmit a deployment command to the barrier device in response to a determination that the geographic location may be subject to a flood, storm, and/or other severe weather phenomena based on the external data received. In some implementations, system may transmit the deployment command to the barrier device in response to a user command. That is, users with administrative privileges may manually control the deployment of barrier devices to prevent pedestrian and/or vehicle from entering a potentially dangerous area.

Any of the features of aspects specified herein are applicable to all other aspects and embodiments identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects. Any aspect of a method can be performed by a system or apparatus of another aspect, and any aspect or of a system can be configured to perform a method of another aspect.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an exemplary flood monitoring and response system configured to deploy barrier devices in response to sensor information, in accordance with one or more implementations.

FIG. 2 illustrates a block diagram illustrating elements of an example flood monitoring response system, in accordance with one or more implementations.

FIG. 3 illustrates an exemplary barrier device that has been deployed in response to sensor information in an example flood monitoring and response system, in accordance with one or more implementations.

FIG. 4 illustrates an exemplary water level sensor configured to communicate with at least one server, in accordance with one or more implementations.

FIG. 5 is a flow chart illustrating various operations that may be performed during deployment of a barrier in an example flood monitoring and response system, in accordance with embodiments disclosed herein.

FIG. 6 illustrates an example computing component that may be used in implementing various features of embodiments of the disclosed technology.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### DETAILED DESCRIPTION

The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

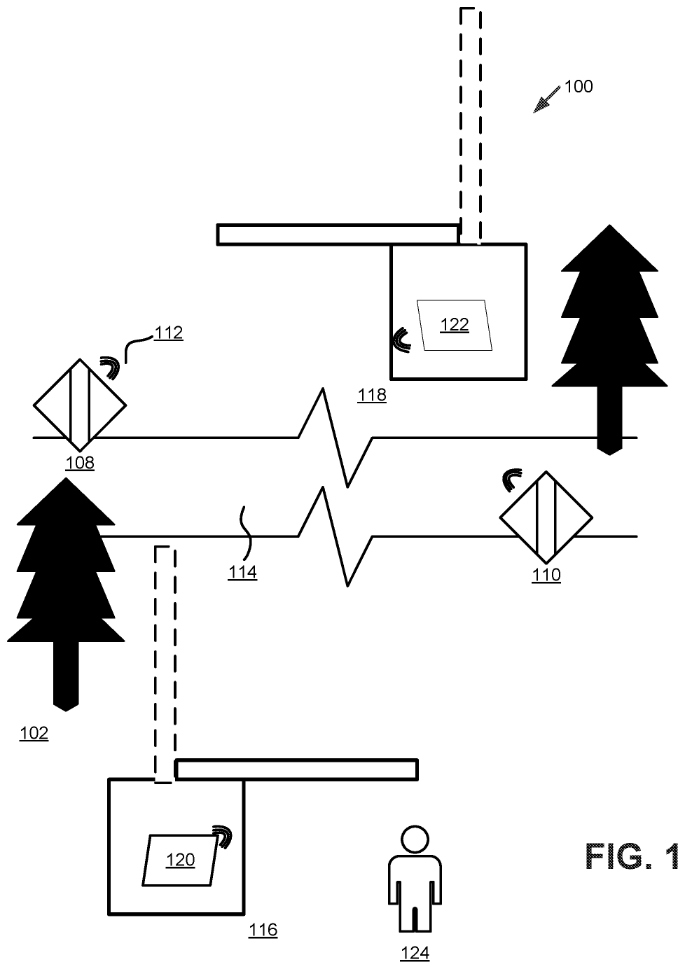

As illustrated in FIG. 1, flood monitoring and response system 100 is provided for measurement of a water level in geographic location 102 that includes at least one water level sensor (e.g., water level sensors 108-110) configured to measure a change in water levels. Water level sensor 108 includes a sensor communication module physically connected to water level sensor 108 and configured to receive water level measurements. The water level measurements may be indicative of the water level measured at geographic location 102. System 100 uses water measurements to determine whether the detected water level satisfies at least one deployment condition. The deployment conditions may include a threshold value corresponding to a threshold water level that may be specified by a user or determined by system 100. In particular, the sensor communication module includes electronics configured to process a data stream associated with a water level measured by the water level sensor in order to generate a command that includes instructions transmitted via wireless communication signal 122 to at least one barrier device (e.g., barrier device 116-118). Instructions transmitted to barrier device 116 may include a command that places barrier device 116 from undeployed position 126 to deployed position 127. In deployed position 127, barrier device 116 may create physical barrier by blocking an entrance to potential motorists attempting to cross road 114. Further, in its deployed position 127, barrier device 116 may warn individuals that road 114 is too dangerous and may be subject to increased water levels, and, thus, should not be crossed.

In some embodiments, the sensor communication module of water level sensor 108 includes electronics configured to process a data stream associated with a water level measured by water level sensor 108 in order to generate sensor information that includes raw sensor data, transformed sensor data, and/or any other sensor data or data derived therefrom, e.g., predictive or trend data. The sensor communication module may further be configured to transmit sensor information to a number of barrier devices and/or other systems. Further, the sensor information may be collected and tracked. By tracking and analyzing water levels, water level sensor 108 is configured to detect whether there is a potential flood or a likely flood within geographic location 102.

Water level sensor 108 may be placed at a user specified location. Water level sensor 108 may be installed or mounted using existing structures or user installed structures. For example, water level sensor 108 may be adjustably mounted on a tree (e.g., tree 138-148) or a utility pole. In some embodiments, water level sensor 108 may be mounted on a structural component specifically installed to hold water level sensor 108 (e.g., a post or a riser). Water level sensor 108 may be mounted at a desired monitoring level. For example, water level sensor 108 may be mounted in close proximity to the surface of the ground in order detect the threshold water level.

In some embodiments, water level sensor 108 may include a float sensor. The float sensor of water level sensor 108 may include a mechanical switch having an electrode that, when water is present, may be triggered when positive and negative electrodes are connected. In some embodiments, the float sensor of water level sensor 108 may include a float. The increase in water may move the float which may trigger the float sensor located at a user specified location. In some embodiments, the float sensor may also detect the movement of the float as the water raises. When the float sensor is activated, the float sensor may send an electronic signal to the sensor communication module. The sensor communication module may determine that the water level, as indicated by float sensor signal, corresponds to the threshold water level and transmit a command to a number of barrier devices.

In some embodiments, water level sensor 108 may be configured to detect a threshold level of water (e.g., six inches). The threshold water level may be specified by a user, determined by system 100, or otherwise obtained. Water level sensor 108 may detect the threshold level of water via the float sensor. Upon the water reaching the threshold level the float sensor may generate a signal that the threshold water level has been reached.

Alternatively, water level sensor 108 may include other types of water level sensors such as float levers, mechanical switches, and/or other such sensors. By way of example, water level sensor 108 may include a water pressure detector to detect water pressure at geographic location 102 where the water sensor 108 is placed. The water pressure may be used to determine a water level on the basis of the water pressure detected by the water pressure detector. The water pressure detector may obtain water pressure by detecting a pressure difference between water pressure applied to a lower surface of the water detector and an atmospheric pressure applied to an upper surface of the water detector. This detected pressure differential may be converted into an electric signal used to determine the water level.

In some embodiments, water level sensor 108 may measure the water level continuously or periodically (e.g., at specified time intervals). The time intervals at which water sensor 108 may measure the water level may be specified by a user, determined by system 100, or otherwise obtained. In some embodiments, the measurement information obtained by water level sensor 108 may be transmitted to a system server indicating that the water levels have reached a certain level.

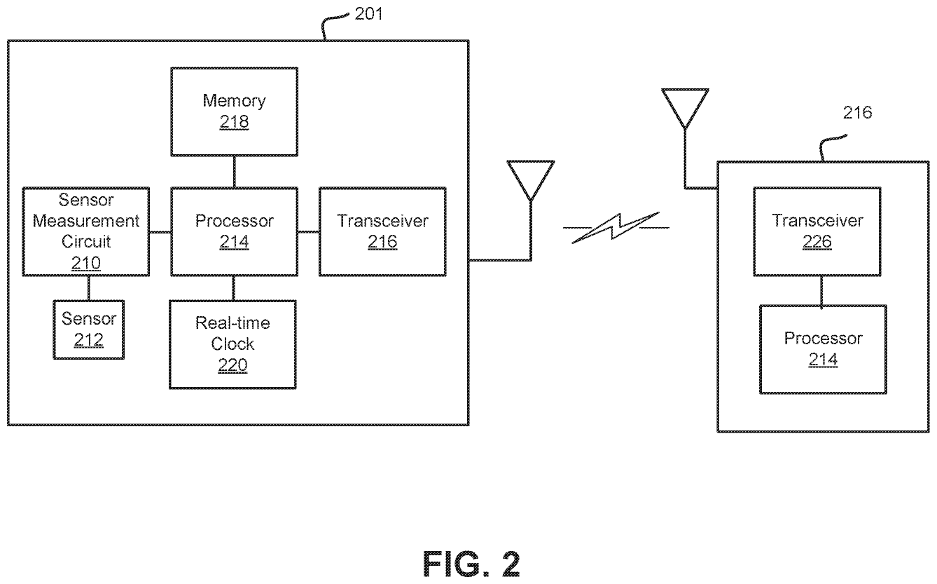

For example, and as illustrated in FIG. 2, flood monitoring and response system 100 (illustrated in FIG. 1) may include water detection system 201 and at least one of the plurality of barrier devices 216 (one embodiment of barrier devices 116-118 of FIG. 1), as well as the communications therebetween. Water detection system 201 may include water level sensor 212 (one embodiment of water level sensors 108-110 of FIG. 1) coupled to sensor measurement circuit 210 for processing and managing sensor data. Sensor measurement circuit 210 may be coupled to processor 214 (part of sensor communication module described in connection with FIG. 1). In some embodiments, processor 214 may perform part or all of the functions of sensor measurement circuit 210 for obtaining and processing sensor measurement values from water level sensor 212. Processor 214 may be further coupled to a radio unit or transceiver 216 for sending requests and commands to an external device, such as barrier device 116. In response to a command from processor 214, barrier device may be deployed by blocking entrance of users onto a road. Barrier device 216 may utilize transceiver 226 and processor 224 to execute commands received from processor 214.

As used herein, the terms “radio unit” and “transceiver” are used interchangeably and generally refer to a device that can wirelessly transmit and receive data. Water detection system 201 may further include memory 218 (also part of sensor communication module in FIG. 1) and real time clock (RTC) 220 (again, part of sensor communication module in FIG. 1) for storing and tracking sensor information.

Wireless communication protocols may be used to transmit and receive data between water detection system 201 and barrier device 216. The wireless communication protocol used may be designed for use in a wireless sensor network that is optimized for periodic and small data transmissions (that may be transmitted at low rates if necessary) to and from multiple devices in a close range (e.g., a personal area network (PAN)). For example, the wireless communication protocol may be optimized for periodic data transfers where transceivers may be configured to transmit data for short intervals and then enter low power modes for long intervals. The wireless communication protocol may have low overhead requirements both for normal data transmissions and for initially setting up communication channels (e.g., by reducing header overhead) to reduce power consumption. In some embodiments, burst broadcasting schemes (e.g., one way communication) may be used. This may eliminate overhead required for acknowledgement signals and allow for periodic transmissions that consume little power.

The wireless communication protocol may further be configured to establish communication channels with multiple display devices, e.g., two or more of barrier devices (e.g., barrier devices 116-118 illustrated in FIG. 1), while implementing interference avoidance schemes. In some embodiments, the wireless communication protocol may make use of adaptive isochronous network topologies that define various time slots and frequency bands for communication with several ones of barrier devices 116-118. The wireless communication protocol may thus modify transmission windows and frequencies in response to interference and to support communication with multiple ones of display barrier devices 116-118. Accordingly, the wireless protocol may use time and frequency division multiplexing (TDMA) based schemes. The wireless communication protocol may also employ direct sequence spread spectrum (DSSS) and frequency-hopping spread spectrum schemes. Various network topologies may be used to support short-distance and/or low-power wireless communication such as point-to-point, peer-to-peer, start, tree, or mesh network topologies such as Wireless I/O Telemetry Radio, WiFi, Bluetooth and Bluetooth Low Energy (BLE). The wireless communication protocol may operate in various frequency bands such as 900 MHz spread-spectrum or open ISM band such as 2.4 GHz. Furthermore, to reduce power usage, the wireless communication protocol may adaptively configure data rates according to power consumption.

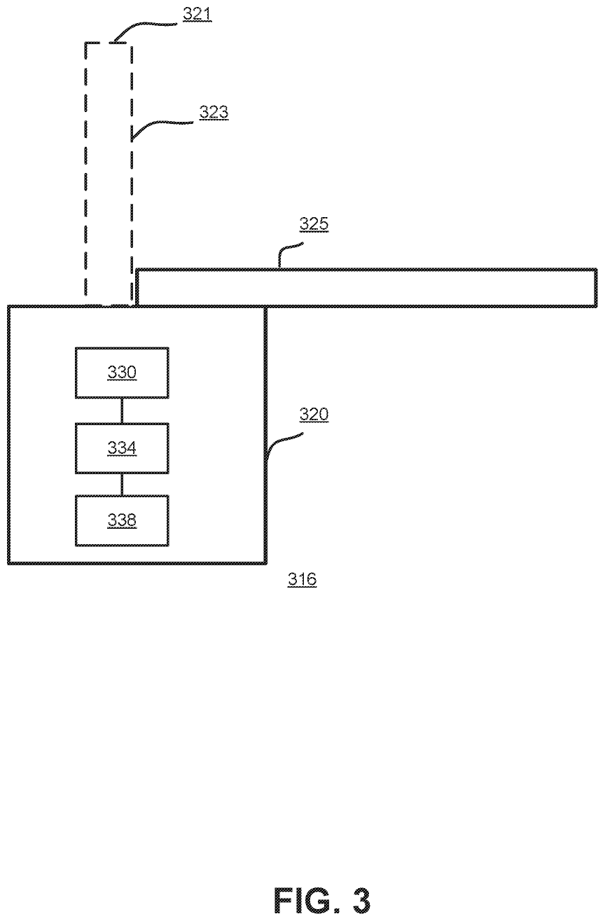

Upon the sensor communication module determining that the water level, as communicated by water level sensor 212, corresponds to a threshold water level, a command comprising command information may be transmitted to a number of barrier devices. As illustrated in FIG. 3, barrier device 316 may include stationary arm 320 and movable arm 321. Barrier device 316 may receive command information including a command instructing barrier device 316 to deploy movable arm 321 and thus prevent vehicles from entering a road which may be subject to flooding. Additionally, barrier device 316 that has received the command to deploy movable arm 321 may signal pedestrians that entering a particular road is dangerous and/or undesirable.

Barrier device 316 may further include processor 330 for processing and managing sensor information and/or command information received from a water level sensor and memory 334. Barrier device 316 may further include a radio unit or transceiver 338 for receiving command information and for sending requests, instructions, and data to a remote server and/or associated databases that may be included in flood monitoring and response system 100 (illustrated in FIG. 1). Transceiver 338 may further employ a wireless communication protocol. Memory 334 may also be used for storing an operating a system and/or a custom (e.g., proprietary) application designed for wireless data communication between a water level sensor barrier device 316. Memory 334 may be a single memory device or multiple memory devices and may be a volatile or non-volatile memory for storing data and/or instructions for software programs and applications. The command information may be executed by processor 330 to control and manage barrier device 316. It should be understood that in the case of barrier device 116, command information, alerts and/or sensor information provided by water level sensor 108 vis-à-vis a sensor communication module (illustrated in FIG. 1), can be used to deploy movable arm 321 from vertical position 323 to horizontal position 325 to signal to the public (e.g., individual 124 illustrated in FIG. 1) that the road (e.g., road 114 illustrated in FIG. 1) is flooded.

In some implementations, barrier devices may be installed on either side of a flooded road. Barrier devices installed in such a manner may be communicatively coupled and may be operated in a synchronized manner. For example, upon receiving command information, provided by the water level sensor, to deploy a movable arm from a vertical position to a horizontal position, a barrier device installed on a first side of a road may transmit a signal to another barrier device installed on a second side of the same road.

In some implementations, barrier device 316 may include a stationary vertical arm movably coupled to a horizontal arm. That is, the horizontal arm of barrier device 316 may be deployed by being rotated from a first position in which the horizontal arm is parallel to a direction of a road to second position in which the vertical arm is perpendicular to the direction of the road. Deploying the horizontal arm from the first position to the second position may signal to the public (e.g., individual 124 illustrated in FIG. 1) that the road (e.g., road 114 illustrated in FIG. 1) is flooded.

In some embodiments, when a standardized communication protocol is used, commercially available transceiver circuits may be utilized that incorporate processing circuitry to handle low level data communication functions such as the management of data encoding, transmission frequencies, handshake protocols, and the like. In these embodiments, processor 330 does need to manage these activities, but rather provide desired data values for transmission, and manage high-level functions such as power up or down, deployment of movable arm 321, and the like. Instructions and data values for performing these high-level functions can be provided to the transceiver 338 circuits via a data bus and transfer protocol established by the manufacturer of the transceiver 338 circuits.

In some embodiments, barrier device 316 may be used to prevent pedestrians and/or vehicles from entering coastal areas during flooding, high tide, and other extreme weather or natural phenomena events (e.g., endangered sea turtle hatching). Additionally, barrier device 316 may be used to assist in high traffic situations (e.g., during festivals, concerts, and sporting events) that require temporary road closures. In the event barrier device 316 is used for road closures in response to a change in measurements such as a change in detected tide level or a change in detected traffic pattern, for example, water level sensor 108 (illustrated in FIG. 1) may comprise additional sensors configured to detect changes in optical signal, acoustic signal, and/or other such signal.

Referring back to FIG. 1, in some embodiments, the sensor communication module physically connected to water level sensor 108 may be configured to transmit commands based on the water level measurements to an assigned barrier device. That is, each water level sensor (e.g., water level sensor 108-110) may be configured to communicate with only one barrier device (e.g., 116-118). For example, water level sensor 108 may be paired with barrier device 116, while water level sensor 110 may be paired with barrier device 118. Additionally, water level sensor and barrier device pairs may be configured to operate in a pattern, such that transmission of a deployment command from water sensor 108 to barrier device 116 may automatically cause water sensor 110 to transmit a deployment command to barrier device 118. The pattern of operation may be specified by a user or may be determined by flood monitoring and response system 100. This determination by flood monitoring and response system 100 may be based on data received from additional sources and or inputs.

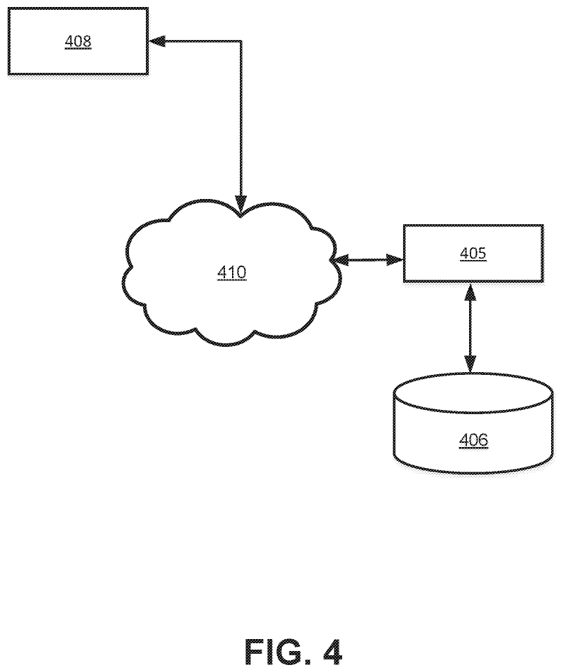

In some embodiments, and as illustrated in FIG. 4, sensor communication module physically connected to water level sensor 408 may transmit sensor information to system gateway 405 which transmits a communication to system server 406. System server 406 may be a remote server and may include a database. That is, water level sensor 408 may communicate directly with system gateway 405 and/or the water level sensor 408 may communicate with the system gateway 405 over a network 410 (e.g., the Internet).

System gateway 405 may receive the sensor information from the water level sensor 408 and transmit the sensor information to system server 406 via network 410. The gateway 405 is connected to the network 410 (e.g., via Ethernet and/or GPRS (General Packet Radio Service)) and may include an antenna and be connected to a power source.

In some embodiments, and referring back to FIG. 1, flood monitoring and response system 100 may receive external data from various sources outside systems. For example, weather report information, historical weather information, historical flood information may be received for the geographic location of water level sensor 108, barrier device 116, and/or other component of system 100. System 100 may transmit a deployment command to barrier device 116 in response to a determination that the geolocation may be subject to a flood, storm, and/or other severe weather phenomena based on the external data received. In some implementations, system 100 may transmit the deployment command to barrier device 116 in response to a user command. That is, users with administrative privileges may manually control the deployment of barrier devices to prevent pedestrian and/or vehicle from entering a potentially dangerous area.

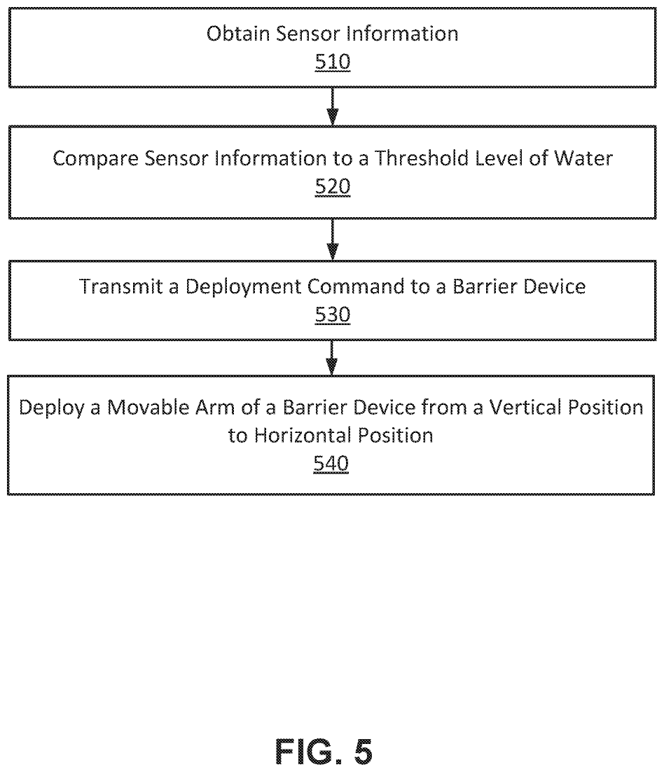

FIG. 5, illustrates a flow chart describing various processes that can be performed during deployment of a barrier in an example flood monitoring and response system, in accordance with one embodiment. At operation 510, a system obtains sensor information associated with a water level sensor. At operation 520, the system compares the sensor information to a threshold level of water. At operation 530, upon the sensor information satisfying the threshold provided by the water level sensor, at operation 520, the system transmits a deployment command to a barrier device. Finally, at operation 540, upon receiving the deployment command from the system in response to the sensor information satisfying the threshold provided by the water level sensor, a movable arm of the barrier device is deployed to from a vertical position to horizontal position.

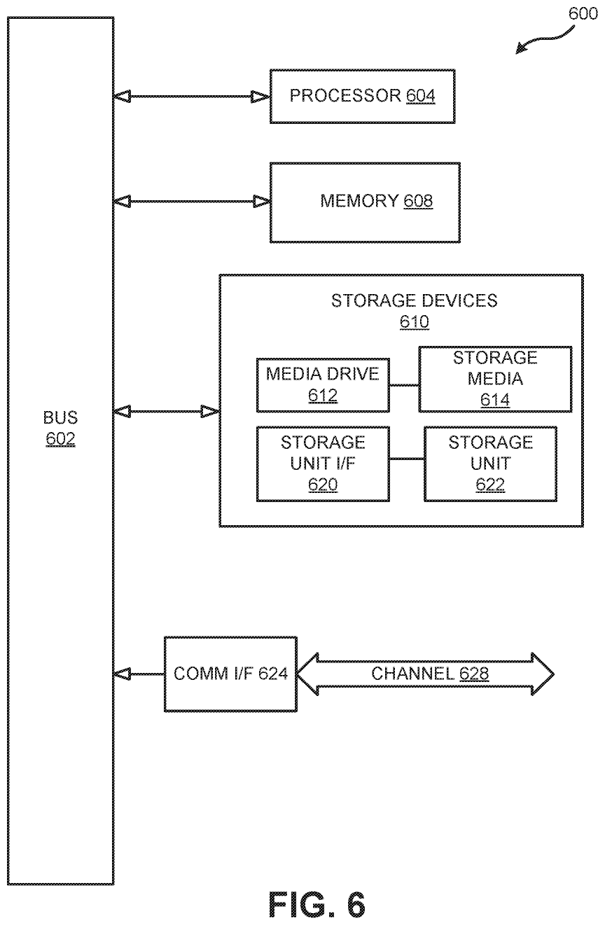

FIG. 6 illustrates an example computing module 600, an example of which may be a processor/controller that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 600. After reading this description, it will become apparent to a person skilled in the relevant art how to implement the application using other computing modules or architectures.

Referring now to FIG. 6, computing module 600 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 600 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, preferably random access memory (RAM) or other dynamic memory might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604.

The computing module 600 might also include one or more various forms of information storage devices 610, which might include, for example, a media drive 612 and a storage unit interface 620. The media drive 612 might include a drive or other mechanism to support fixed or removable storage media 614. For example, a hard disk drive, a floppy disk drive, a magnetic tape drive, an optical disk drive, a CD or DVD drive (R or RW), or other removable or fixed media drive might be provided. Accordingly, storage media 614 might include, for example, a hard disk, a floppy disk, magnetic tape, cartridge, optical disk, a CD or DVD, or other fixed or removable medium that is read by, written to or accessed by media drive 612. As these examples illustrate, the storage media 614 can include a computer usable storage medium having stored therein computer software or data.

In alternative embodiments, information storage devices 610 might include other similar instrumentalities for allowing computer programs or other instructions or data to be loaded into computing module 600. Such instrumentalities might include, for example, a fixed or removable storage unit 622 and a storage unit interface 620. Examples of such storage units 622 and storage unit interfaces 620 can include a program cartridge and cartridge interface, a removable memory (for example, a flash memory or other removable memory module) and memory slot, a PCMCIA slot and card, and other fixed or removable storage units 622 and interfaces 620 that allow software and data to be transferred from the storage unit 622 to computing module 600.

Computing module 600 might also include a communications interface 624. Communications interface 624 might be used to allow software and data to be transferred between computing module 600 and external devices. Examples of communications interface 624 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 624 might typically be carried on signals, which can be electronic, electromagnetic (which includes optical) or other signals capable of being exchanged by a given communications interface 624. These signals might be provided to communications interface 624 via a channel 628. This channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 608, storage unit interface 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 600 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for deploying a road barrier, the method comprising:
receiving sensor information;
calculating and storing estimated water level measurement values based upon the received sensor information;
determining one or more deployment conditions;
instructing a transceiver to send a deployment command to at least a first barrier device in accordance with one or more communication variables based upon the one or more deployment conditions; and
transmitting the water level measurement values to a server.

2. The computer-implemented method of claim 1, wherein the sensor information is received from a water monitoring sensing device.

3. The computer-implemented method of claim 2, wherein the water monitoring sensing device comprises at least one of a pressure sensor, an acoustic sensor, and a stream gauge.

4. The computer-implemented method of claim 1, wherein the water level measurement values comprise estimated rainfall values.

5. The computer-implemented method of claim 1, wherein determining the one or more deployment conditions comprises determining an existence of a deployment condition.

6. The computer-implemented method of claim 5, wherein the deployment condition comprises a determination that the water level measurement values are approaching a threshold value indicative of a flood.

7. The computer-implemented method of claim 1, wherein the sensor information is received at user specified time intervals.

8. The computer-implemented method of claim 1, wherein the one or more communication variables are optimized for establishing a wireless communication session with the first barrier device.

9. The computer-implemented method of claim 1, wherein the first barrier device comprises a stationary gate comprising a fixed arm and a movable arm, wherein the movable arm is configured to move from a vertical position to a horizontal position.

10. The computer-implemented method of claim 9, wherein upon receiving the deployment command from the transceiver, the arm of the first barrier is moved from the vertical position into the horizontal position.

11. An apparatus, comprising:
signal conditioning circuitry communicatively connected to a water level detecting sensor for receiving sensor information from the water level detecting sensor indicative of water levels of a geographic location to which the water level sensor is operatively attached;
a processor, wherein upon receiving the sensor information from the signal conditioning circuitry, instructs a radio to perform the following:
establish a wireless communication session with a first barrier device in accordance with one or more communication variables based upon one or more deployment conditions determined by the apparatus; and
upon establishing the communication session with the first barrier device, transmit a command causing the first barrier device to be deployed.

12. The apparatus of claim 11, wherein determining the one or more deployment conditions comprises determining an existence of a deployment condition.

13. The apparatus of claim 12, wherein the deployment condition comprises a determination that the water level measurement values are approaching a threshold value indicative of a flood.

14. The apparatus of claim 11, wherein the sensor information comprises raw sensor data indicative of water levels at the geographic location, and wherein the water level values derived from the sensor information comprises estimated rainfall values at the geographic location.

15. The apparatus of claim 11, wherein the one or more communication variables comprise at least one of:
a transmission protocol indicating a wireless communication protocol to be utilized in the transmission of the deployment command to the first barrier device; and
a communications type variable indicating a one-way communication or a two-way communication with the first display during the transmission of the deployment command to the first display device.

16. The apparatus of claim 11, further comprising transmitting the water level measurement values to a server.

17. The apparatus of claim 14, wherein the sever is configured to transmit the water level measurement values to at least one user communication device.
